(19) United States
(12) Patent Application Publication
(10) Pub. No.: US 2010/0100960 A1
(43) Pub. Date: Apr. 22, 2010

(54) SYSTEM AND METHOD FOR PROTECTING DATA OF NETWORK USERS

(75) Inventors: I-Fang Wu, Taipei (TW); Feng-Peng Yu, Taipei (TW); Wei Lee, Taipei (TW); Ming-Shan Shyu, Taipei (TW); Yuan-Ting Hsu, Taipei (TW); Jen Yu, Taipei (TW)

Correspondence Address: EDWARDS ANGELL PALMER & DODGE LLP, P.O. BOX 55874, BOSTON, MA, 02205, US

(73) Assignee: CHUNGHWA TELECOM CO., LTD., Taipei (TW)

(21) Appl. No.: 12/569,245

(22) Filed: Sep. 29, 2009

(30) Foreign Application Priority Data
Oct. 16, 2008 (TW) 097139692

(51) Int. Cl. G06F 21/00; H04L 12/28

(52) U.S. Cl. 726/24; 370/351; 726/22

(57) ABSTRACT

A system and method for protecting data of network users are provided. A user end device is connected to a routing device. Then, the routing device directs data packets of the user end device into a data protection device connected to the routing device in series, according to profiles corresponding to the user end device. Security services are performed on the received data packets by the data protection device, thereby providing effective data security protection services to network users and overcoming the drawbacks of high costs and high maintenance required for self-configuration of such mechanisms in prior techniques.

### FIELD OF THE INVENTION

The present invention relates to systems and methods for protecting data of network users, and more particularly, to a system and method for directing data packets of the network users into specific routing paths to implement various data security services.

### BACKGROUND OF THE INVENTION

Network systems have been constructed in increasingly faster speed with the development of network technologies. With the omnipresence of networks, users tend to conduct daily activities through networks, such as using network to search for data, purchase merchandise or even make friends.

For the Internet, users normally connect online through an Internet Service Provider (ISP). ISPs are companies or organizations that provide Internet access and network information services to users by renting lines and large bandwidths and distribute them down to ordinary users with charges. Usually, users connect to the Internet through leased lines or dial-up offered by the ISP.

Nowadays, viruses and malicious programs are spreading all over the Internet, causing computer break down and data lost/leak. Current approach for data protection is that the users have to buy and install firewall software/hardware themselves or install security equipments within the internal network to block viruses and malicious programs. However, the types of malicious programs are constantly evolving, so network users have to update or install new security equipments from time to time, increasing the burden for implementing and maintaining security measures. Such an approach is not effective for stopping viruses and hacker attacks. Even if a malicious packet is blocked successfully, one cannot prevent bandwidth reduction due to large amount of malicious packets.

Therefore, there is a need for a system and method for protecting data of network users that effectively solves the above addressed shortcomings.

### SUMMARY OF THE INVENTION

In the light of foregoing drawbacks, the present invention provides a data protection method and system for network users to stop malicious packets or programs attacking user end devices, thereby improving level of data security of the user ends.

Further, the present invention provides a data protection method and system for network users that effectively reduces cost of configuring and maintaining data security mechanisms and enhances the efficiency of network bandwidths usage.

In accordance with the above and other objectives, the present invention provides a data protection system and method for network users. The data protection system for network users according to the present invention comprises: a user end device; a routing device connected to the user end device and configured to direct data packets of the user end device into a specific routing path based on a profile corresponding to the user end device; and a data protection device connected to the routing device in series and configured to receive the data packets via the specific routing path and perform a security service on the data packets.

The present invention further provides a data protection system for network users, comprising: a user end device; a routing device connected to the user end device and configured to mirror data packets of the user end device based on a profile corresponding to the user end device and direct the data packets mirrored into a specific routing path; and a data protection device connected to the routing device and configured to receive the data packets mirrored via the specific routing path and perform a security service on the data packets mirrored.

The present invention further provides a data protection system for network users, comprising: a user end device; a routing device connected to the user end device and configured to direct data packets of the user end device into a specific routing path based on a profile corresponding to the user end device; and a proxy server device connected to the routing device for receiving and transmitting the data packets on behalf of the user end device, wherein the proxy server device receives the data packets via the specific routing path so as to perform a security service on the data packets received.

The data protection method for network users according to the present invention comprises the following steps: (1) allowing a user end device to connect with a routing device; (2) allowing the routing device to direct data packets of the user end device into a data protection device connected to the routing device in series based on a profile corresponding to the user end device; and (3) allowing the data protection device to perform a security service on the data packets received.

The present invention further provides a data protection method for network users, comprising the following steps: (1) allowing a user end device to connect with a routing device; (2) allowing the routing device to mirror data packets of the user end device according to a profile corresponding to the user end device and direct the data packets mirrored into a data protection device connected to the routing device; and (3) allowing the data protection device to perform a security service on the data packets mirrored.

The present invention further provides a data protection method for network users, comprising the following steps: (1) allowing a user end device to connect with a routing device; (2) allowing the routing device to connect with a proxy server device and transmit data packets of the user end device through the proxy server device; and (3) allowing the proxy server device to perform a security service on the data packets received.

Compared to the prior art, the data protection system and method for network users according to the present invention exploits profiles of the user end devices to determine the transmission routing paths of the data packets, and directs the data packets into the data protection device for data security process. As a result, network viruses and hacker attacks can be successfully blocked at the ISP side, while network bandwidth can be efficiently utilized. Moreover, users do not need to self-configure data security apparatuses, thereby reducing associated costs.

### BRIEF DESCRIPTION OF THE DRAWINGS

The present invention can be more fully understood by reading the following detailed description of the preferred embodiments, with reference made to the accompanying drawings, wherein:

FIG. 1 is a block diagram depicting a data protection system for network users according to the present invention;

FIG. 2 is a block diagram depicting another data protection system for network users according to the present invention;

FIG. 3 is a block diagram depicting yet another data security system for network users according to the present invention;

FIG. 4 is a block diagram depicting an actual implementation of the data protection system for network users according to the present invention;

FIG. 5 is a block diagram depicting another actual implementation of the data protection system for network users according to the present invention;

FIG. 6 is a block diagram depicting yet another actual implementation of the data protection system for network users according to the present invention;

FIG. 7 is a flowchart illustrating a data protection method for network users according to the present invention;

FIG. 8 is a flowchart illustrating another data protection method for network users according to the present invention;

FIG. 9 is a flowchart illustrating yet another data protection method for network users according to the present invention; and

FIG. 10 is a flowchart illustrating an actual implementation of the data protection method for network users according to the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of the specification. The present invention can also be implemented with different embodiments. Various details described in the specification can be modified based on different viewpoints and applications without departing from the scope of the present invention.

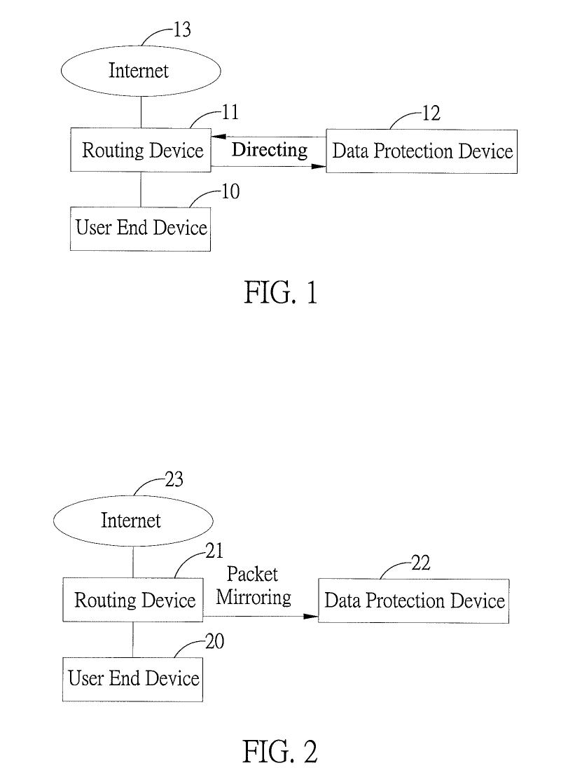

Referring to FIG. 1, a block diagram depicting a data protection system for network users according to the present invention is shown. The data protection system includes a user end device 10, a routing device 11, a data protection device 12 and the Internet 13.

The user end device 10 can be an electronic apparatus capable of accessing and processing data, such as a desktop computer, a laptop computer, a digital TV, a PDA and/or a mobile phone.

The routing device 11 is used to provide connection routing paths for the user end device 10. For data to be transmitted over the Internet 13, the routing device 11 determines the paths for transmitting them. Since the data are divided into multiple packets, where the packets should point to is determined by the routing device 10. Thus, when the user end device 10 uploads or receives data packets, the routing device 11 directs the data packets to specific routers or servers.

The protecting device 12 is used to protect safety of the packets coming from the routing device 11. In order to avoid the user end device 10 from receiving or transmitting abnormal packets, the data protection device 12 performs various kinds of data security measures on the packets. The contents of data security measures may include virus scanning and cleaning, blocking malicious packets and/or malicious connections.

In implementation of the present invention, the user end device 10 is first connected to the routing device 11. Then, the routing device 11 generates routing paths based on a profile corresponding to the user end device 10. After the user end device 10 uploads a packet, the routing device 11 directs the packet into a specific routing path using a policy-based routing (PBR) technique, so as for the packet to be transmitted to the data protection device 12 for implementing data security measures. The profile is established at the time when the user end applied for an Internet connection or service, and written according to the PBR technique. It should be noted that the routing device 11 and the profile are not limited to the PBR technique, but can use any communication protocol that identifies user end request and directs that request to a specific routing path. Moreover, the data protection device 12 is connected to another platform through the Internet 13 to implement security measures.

In a preferred embodiment, the user end device 10 is connected to the routing device 11 through a Wide Area Network (WAN), a Virtual Private Network (VPN), a Local Area Network (LAN) and/or wireless network.

In another preferred embodiment, the routing device 11 further includes a plurality of access routers for transmitting data packets using the Generic Routing Encapsulation tunneling technique.

In yet another preferred embodiment, the routing device 11 forms a plurality of virtual routers based on different profiles, thus providing a plurality of routing paths for packet transmission.

Referring to FIG. 2, a block diagram depicting another data protection system for network users according to the present invention is shown. The data protection system shown in FIG. 2 includes a user end device 20, a routing device 21, a data protection device 22 and the Internet 23. The operations are described below.

The user end device 20 has already applied to an ISP for a data security feature. The user end device 20 is then able to receive/transmit data packets from/to the Internet 23 through the routing device 21 provided by the ISP. The routing device 21 can mirror the data packets of the user end device to the data protection device 22, and the data protection device 22 may implement the data security feature on the data packets. If the data protection device 22 finds that the webpage to which the user linked has inappropriate contents or the webpage is a malicious webpage, it signals the user end device 20 to stop the linking action, thus improving the security when user is using the Internet.

In a preferred embodiment, the data protection device 22 can connect to other platform through the Internet 23 to implement security measures.

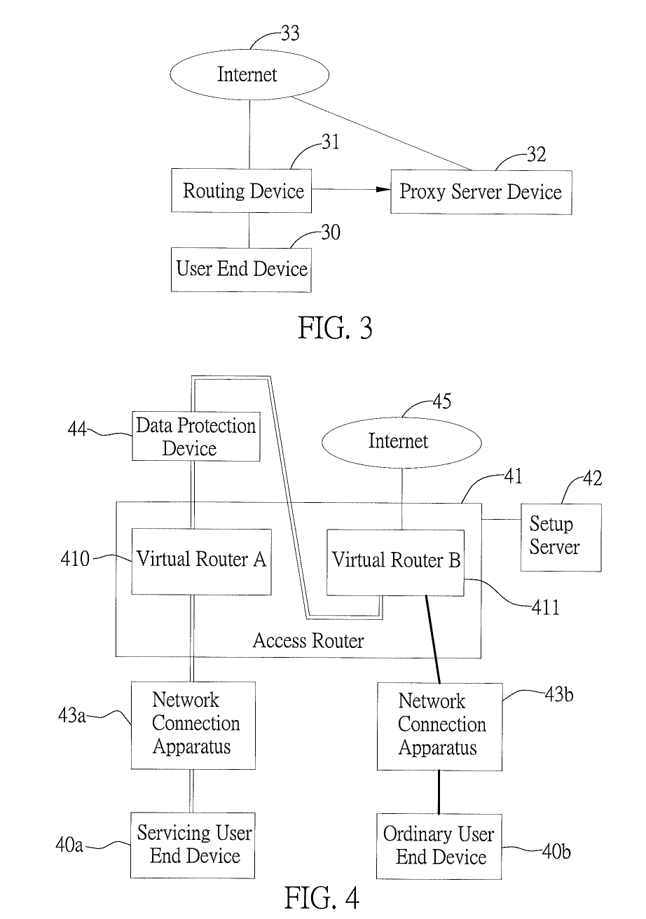

Referring to FIG. 3, a block diagram depicting yet another data protection system for network users according to the present invention is shown. The data protection system shown in FIG. 3 includes a user end device 30, a routing device 31, a proxy server device 32 and the Internet 33. The operations are described below.

Compared to the data protection system shown in FIG. 2, the data protection system shown in FIG. 3 exploits the proxy server device 32 to provide data security services. The proxy server device 32 is connected to the routing device 31 and the Internet 33 for receiving/transmitting data packets on behalf of the user end device 30. For users who did not apply for the data security service, their data packets are transmitted to the Internet through the routing device 31. While for users who have applied for the data security service, the packets transmitted between the user end device 30 and the Internet 33 must go through the proxy server device 32. Thus, the present invention uses the proxy server device 32 to implement various data security measures on data packets, preventing any malicious packets or virus invasion from the user end device 30.

Referring to FIG. 4, a block diagram depicting an actual implementation of the data protection system for network users according to the present invention is shown. In actual implementation, an ordinary user end device 40b connects to an access router 41 through a network connection apparatus 43b. The access router 41 is divided into a virtual router A 410 and a virtual router B 411. Since the ordinary user end device 40b only applies for a network connection service, so when a data packet enters into the access router 41, the virtual router B 411 directs the packet to the Internet 45. Similarly, data packets transmitted from the Internet 45 to the ordinary user end device 40b are transmitted to the ordinary user end device 40b through the access router 41, in particular, the virtual router B 411.

For security service user end device 40a, when it connects to the access router 41 through a network connection apparatus 43a, the virtual router 410 will direct the packet coming from the security service user end device 40a to a data protection device 44, where data packet is processed before being transmitted to the virtual router 411, which in turn directs the packet to the Internet 45. On the other hand, the data packets coming from the Internet 45 to the security service user end device 40a are transmitted through the same path, after being processed by the data protection device 44, they are directed to the virtual router 410, and then from there to the user end device 40a.

In a preferred embodiment, a setup server 42 provides profiles of the corresponding security service user end devices 40a to the access router 41, and then the virtual router A 410 directs data packets from the security service user end device 40a to the data protection device 44.

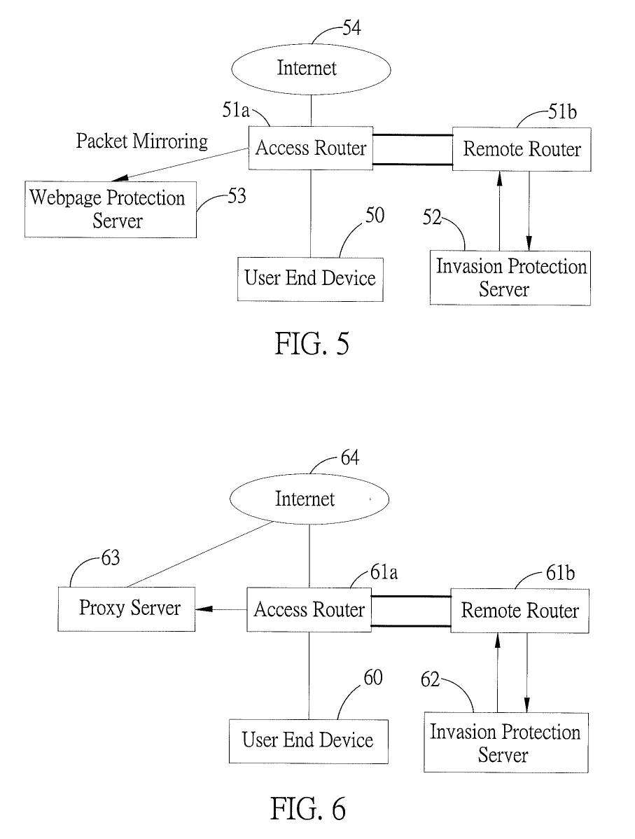

Referring to FIG. 5, a block diagram depicting another actual implementation of the data protection system for network users according to the present invention is shown. Compared to the routing device illustrated in FIGS. 1 to 3, the data protection system shown in FIG. 5 is implemented particularly through an access router 51a and a remote router 51b.

In actual implementation, since the local access router 51a is not directly connected to a security server 52, so the access router 51a can connect to the remote router 51b through the GRE tunneling technique. When a user end device 50 wishes to transmit data packets, the access router 51a is responsible for directing the packets to an invasion prevention server 52 connected to the remote router 51b. The advantage of this is that when the ISP end does not have security apparatus in a certain region, it may use data transmission technique (e.g. the GRE tunneling technique) to send the packets to the remote router 51b having the invasion preventing server 52 for process, reducing the investment of the ISP required for implementing data security apparatuses. Moreover, the present embodiment further provides a webpage protection apparatus 53 for analyzing and controlling the network behavior of users. For example, when the access router 51a detects that the user end device 50 wishes to connect to a webpage, it mirrors (backs up) a copy of the data packets to the webpage protection apparatus 53 for analysis through the router 51a. If the webpage is found to be inappropriate or malicious, then it notifies the user end device 53 to stop linking to that webpage. The embodiment combines two security features, reducing the workload of the invasion protection server 52.

Referring to FIG. 6, a block diagram depicting yet another actual implementation of the data protection system for network users according to the present invention is shown. In actual implementations, an access router 61a connects to a remote router 61b via the GRE tunneling technique. When a user end device 60 transmits a data packet to the access router 61a, the access router 61a directs the packet to an invasion protection server 62 connected to the remote router 61b for implementing security measures. The, the packet is sent back to the access router 61a. If the user did not apply for the security service of the proxy server 63, then the access router 61a transmits that packet to the Internet 64. On the other hand, if the user applied the security service of the proxy server 63, then the packet needs to be transmitted to the proxy server 63 before sending to the Internet 64.

In a preferred embodiment, the proxy server provides security services such as virus scanning, cleaning, malicious packet/connection blocking, invasion denial, invasion detection, content screening, webpage threat protection and/or virus protection.

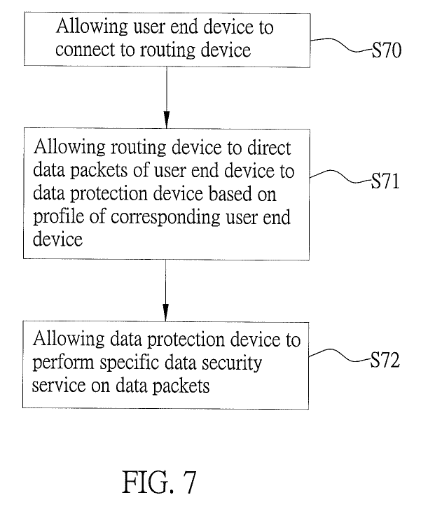

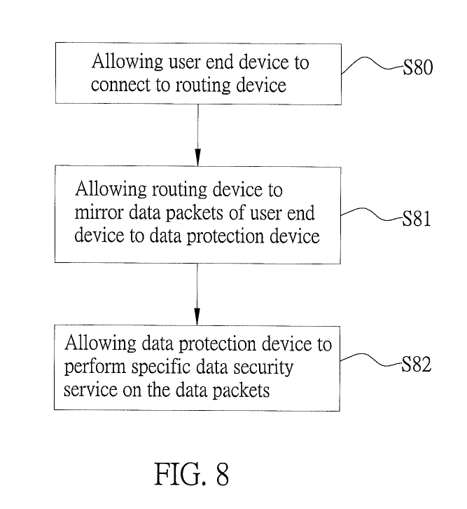

Referring to FIG. 7, which is a flowchart illustrating a data protection method for network users according to the present invention, the steps of implementing the method are described below.

In step S70, allow a user end device to connect to a routing device. The user end device may be connected to the routing device through a WAN, a VPN, a LAN and/or wireless network. The user end device may be a desktop computer, a laptop computer, a PDA and/or a mobile phone. Then, proceed to step S71.

In step S71, allow the routing device to direct data packets of the user end device to a data protection device based on a profile of the corresponding user end device. Then, proceed to step S72.

In step S72, allow the data protection device to perform a data security service on the data packets.

The above data protection method for network users may, in other preferred embodiment, further includes the following steps.

First, the data packet of the corresponding user end device is mirrored to the data protection device by the routing device. Then, a data security service is performed on the data packet by the data protection device.

The above data protection method for network users may, in other preferred embodiment, further include the following steps.

First, packet transmission is performed by a proxy server device, and then a security service is performed on the data packet by the proxy server device.

Referring to FIG. 8, which is a flowchart illustrating another data protection method for network users according to the present invention, the steps of implementing the method are described below.

In step S80, allow a user end device to connect to a routing device. Then, proceed to step S81.

In step S81, allow the routing device to mirror data packets of the user end device to a data protection device. Then, proceed to step S82.

In step S82, allow the data protection device to perform a data security service on the data packets.

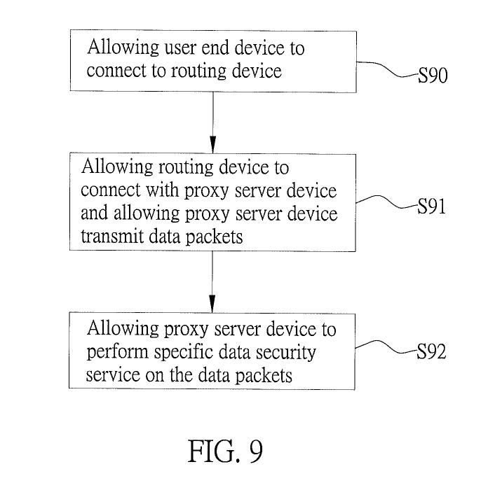

Referring to FIG. 9, which is a flowchart illustrating yet another data protection method for network users according to the present invention, the steps of implementing the method are described below.

In step S90, allow a user end device to connect to a routing device. Then, proceed to step S91.

In step S91, allow the routing device to connect to a proxy server device, and allowing the proxy server device to perform data packet transmission. Then, proceed to step S92.

In step S92, allow the proxy server device to perform a data security service on the data packets.

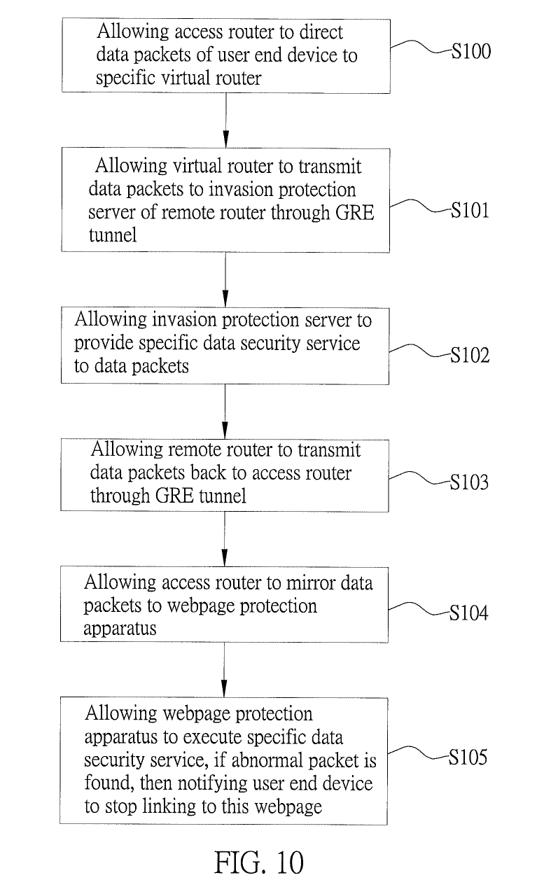

Referring to FIG. 10, which is a flowchart illustrating an actual implementation of the data protection method for network users according to the present invention, the steps of implementing the method are described below.

In step S100, allow an access router to direct data packets of a user end device to a specific virtual router. Then, proceed to step S101.

In step S101, allow the virtual router to transmit the data packets to an invasion protection server of a remote router through a GRE tunnel. Then, proceed to step S102.

In step S102, allow the invasion protection server to provide a security service to the data packets. Then, proceed to step S103.

In step S103, allow the remote router to transmit the packets back to the access router through the GRE tunnel. Then, proceed to step S104.

In step S104, allow the access router to mirror the data packets to a webpage protection apparatus. Then, proceed to step S105.

In step S105, allow the webpage protection apparatus to perform a security service. If an abnormal packet is found, then it notifies the user end device to stop linking to the webpage.

It can be observed from the above that the present invention generates and defines different routing paths based on different network users' application contents. Different data security services can be provided in different routing paths, so that a more flexible data security service can be provided. Meanwhile, users save the trouble and cost for installing security apparatus themselves.

Therefore, the data protection method and system for network users utilizes profiles of the network users to setup the routing path of the access routers. The routing path points towards the data protection device, thereby preventing malicious packets from entering into user devices and from spreading upwards across the Internet.

In summary, the data protection method and system for network users according to the present invention has the following features:

(1) improving data packet management by avoiding simultaneously receiving and processing a large amount of packets which would reduce server performance. The access router branches and controls data streams and provides different services based on user profiles, thereby eliminating workload of the server becoming too large.

(2) increasing efficiency of outbound network bandwidths. By blocking malicious packets trying to enter the user's routing path at the security apparatus of the ISP, the efficiency of the outbound network bandwidths may thus increase.

(3) reducing cost for installing data protection mechanisms. Since the ISP can perform data security measures for the users, the users no longer need to install data protection apparatuses themselves (e.g. firewall or antivirus software).

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A data protection system for network users, the data protection system comprising:
a user end device;
a routing device connected to the user end device and configured to direct data packets of the user end device into a specific routing path based on a profile corresponding to the user end device; and
a data protection device connected to the routing device in series and configured to receive the data packets via the specific routing path and perform a security service on the data packets.

2. The data protection system for network users of claim 1, wherein the user end device connects with the routing device through one or more of a wide area network, a virtual private network, a local area network and a wireless network.

3. The data protection system for network users of claim 1, wherein the user end device is one of a workstation, a desktop computer, a notebook computer, a personal digital assistant and a mobile phone.

4. The data protection system for network users of claim 1, wherein the routing device includes a plurality of access routers.

5. The data protection system for network users of claim 1, wherein the security service includes at least one of virus scanning, virus cleaning, malicious packet blocking, malicious connection blocking, invasion denial, invasion detection, content screening, webpage threat protection and virus protection.

6. A data protection system for network users, the data protection system comprising:
a user end device;
a routing device connected to the user end device and configured to mirror data packets of the user end device based on a profile corresponding to the user end device and direct the data packets mirrored into a specific routing path; and
a data protection device connected to the routing device and configured to receive the data packets mirrored via the specific routing path and perform a security service on the data packets mirrored.

7. The data protection system for network users of claim 6, wherein the user end device connects with the routing device through one or more of a wide area network, a virtual private network, a local area network and a wireless network.

8. The data protection system for network users of claim 6, wherein the user end device is one of a workstation, a desktop computer, a notebook computer, a personal digital assistant and a mobile phone.

9. The data protection system for network users of claim 6, wherein the routing device includes a plurality of access routers.

10. The data protection system for network users of claim 6, wherein the security service includes at least one of virus scanning, virus cleaning, malicious packet blocking, malicious connection blocking, invasion denial, invasion detection, content screening, webpage threat protection and virus protection.

11. A data protection system for network users, the data protection system comprising:
a user end device;
a routing device connected to the user end device and configured to direct data packets of the user end device into a specific routing path based on a profile corresponding to the user end device; and
a proxy server device connected to the routing device for receiving and transmitting the data packets on behalf of the user end device, wherein the proxy server device receives the data packets via the specific routing path so as to perform a security service on the data packets received.

12. The data protection system for network users of claim 11, wherein the user end device connects with the routing device through one or more of a wide area network, a virtual private network, a local area network and a wireless network.

13. The data protection system for network users of claim 11, wherein the user end device is one of a workstation, a desktop computer, a notebook computer, a personal digital assistant and a mobile phone.

14. The data protection system for network users of claim 11, wherein the routing device includes a plurality of access routers.

15. The data protection system for network users of claim 11, wherein the security service includes at least one of virus scanning, virus cleaning, malicious packet blocking, malicious connection blocking, invasion denial, invasion detection, content screening, webpage threat protection and virus protection.

16. The data protection system for network users of claim 15, wherein the plurality of access routers transmit the data packets by Generic Routing Encapsulation (GRE) tunneling technique.

17. The data protection system for network users of claim 1, further comprising another data protection device connected to the routing device, wherein the routing device mirrors the data packets of the user end device and directs the data packets mirrored into the another data protection device so as for the another data protection device to perform a security service on the data packets.

18. The data protection system for network users of claim 1, further comprising a proxy server device connected to the routing device for receiving and transmitting the data packets on behalf of the user end device, wherein the proxy server device performs a security service on the data packets after the data packets have been received via the specific routing path.

19. A data protection method for network users, comprising the following steps:
(1) allowing a user end device to connect with a routing device;
(2) allowing the routing device to direct data packets of the user end device into a data protection device connected to the routing device in series based on a profile corresponding to the user end device; and
(3) allowing the data protection device to perform a security service on the data packets directed from the routing device.

20. The data protection method for network users of claim 19, wherein the routing device forms a plurality of access routers based on different profiles.

21. The data protection method for network users of claim 20, further comprising:
(4) allowing the routing device to mirror the data packets of the user end device and direct the data packets mirrored into another data protection device connected to the routing device; and
(5) allowing the another data protection device to perform a security service on the data packets mirrored.

22. The data protection method for network users of claim 20, further comprising:
(4) transmitting the data packets through a proxy server device connected to the routing device; and
(5) allowing the proxy server device to perform a security service on the data packets received.

23. A data protection method for network users, comprising the following steps:
(1) allowing a user end device to connect with a routing device;
(2) allowing the routing device to mirror data packets of the user end device based on a profile corresponding to the user end device and direct the data packets mirrored into a data protection device connected to the routing device; and
(3) allowing the data protection device to perform a security service on the data packets mirrored.

24. The data protection method for network users of claim 23, wherein the routing device forms a plurality of access routers based on different profiles.

25. A data protection method for network users, comprising the following steps:
(1) allowing a user end device to connect with a routing device;
(2) allowing the routing device to connect with a proxy server device and transmit data packets of the user end device through the proxy server device; and
(3) allowing the proxy server device to perform a security service on the data packets received.

26. The data protection method for network users of claim 25, wherein the routing device forms a plurality of access routers based on different profiles.

27. The data protection method for network users of claim 26, wherein the plurality of access routers provide a plurality of routing paths.

28. The data protection method for network users of claim 26, wherein the plurality of access routers transmit the data packets by Generic Routing Encapsulation (GRE) tunneling technique.
